(19) United States
(12) Patent Application Publication
(10) Pub. No.: US 2016/0018071 A1
(43) Pub. Date: Jan. 21, 2016

(54) PORTABLE LIGHT HAVING PLURAL LIGHT SOURCES, AND OPTIONALLY A CLIP

(71) Applicant: Streamlight, Inc., Eagleville, PA (US)

(72) Inventors: RAYMOND L. SHARRAH, COLLEGEVILLE, PA (US); W. Ross McLennan, Perkasie, PA (US); Thomas D. Boris, Collegeville, PA (US)

(21) Appl. No.: 14/791,945

(22) Filed: Jul. 6, 2015

Related U.S. Application Data
(63) Continuation of application No. 29/496,898, filed on Jul. 18, 2014.
Application No. 29/496,898 is a continuation-in-part of application No. 14/448,483, filed on Jul. 31, 2014.

(51) Int. Cl. F21L 4/02; F21V 23/04; F21V 21/088

(52) U.S. Cl. CPC F21L 4/025; F21V 21/0885; F21V 23/0414; F21W 2131/30

(57) ABSTRACT

A portable light comprises: a light body extending from a light head, one or more light sources supported by the light head and energizable to produce light, and one or more switches for selectively energizing the light sources. In one embodiment, the one or more switches are at substantially diametrically opposite locations on the light body, and plural light emitting sources and/or a light emitting source and a laser light source may be provided. In another embodiment, the light body defines an envelope line extending along a side thereof and has a recess inward of the envelope line. A clip may be configured to be disposed substantially in the recess of the light body and within the envelope line of the light body.

This Application is a continuation-in-part of and claims the benefit of the priority of U.S. patent application Ser. No. 14/448,483 entitled “PORTABLE LIGHT HAVING A CLIP” which was filed on Jul. 31, 2014, which is a continuation of and claims the benefit of the priority of U.S. patent application Ser. No. 29/496,898 entitled “PORTABLE LIGHT HAVING A CLIP” which was filed on Jul. 18, 2014, each of which is hereby incorporated herein by reference in its entirety.

The present invention relates to a portable light. In one aspect it relates to a portable light having at least two light sources and related actuators, and/or in another aspect it relates to a portable light having a clip in a recess.

There are many different configurations of portable lights, of different sizes and shapes, intended for use in a wide variety of applications. Many of these portable lights are for use where it is convenient that the light be supported by an object, and so such lights often have a loop, hook, clip, lanyard or other feature for facilitating the light being attached to and/or supported by an object. Typically such features extend beyond the outline or envelope of the light so that they can attach the light to a desired object.

Features that extend significantly beyond the outline or envelope of a portable light, however, are susceptible to becoming snagged, caught on or otherwise engaging unwanted objects that the light happens to be or come near, e.g., clothing, ropes, cables, wires and the like. This can dislodge the light from the grip of the user or from an object to which the light is attached by the clip. As a result the dislodged light can fall and become damaged or can damage or injure whatever it falls upon or can be rendered inoperative. In any case, when that occurs the light is not in position to direct light to where the user wants light directed and so may cause a danger or risk of injury to the user of the portable light or to others. Such danger and risk may be greater when the light is used in hazardous or dangerous locations.

Further, for certain uses it may be desired that a portable light provide more than one light output, e.g., provide light from more than one light source. And where plural light sources are provided in a portable light, energizing the plural light sources may be inconvenient and/or confusing. For certain uses, the plural light sources may include an illumination light beam, e.g., directed forwardly, and a second illumination light beam, e.g., directed downwardly or to the side. For other uses, the plural light sources may include in addition to an illumination light beam, a laser light that projects a very narrow beam in a desired direction.

It also may be desirable that such portable lights be usable safely in hazardous and/or dangerous locations.

Applicant believes there may be a need for a portable light that provides plural light sources, e.g., plural illumination beams or both an illumination beam and a laser light and that has a particular arrangement of the actuators for the plural beams, e.g., for a forwardly directed beam and for a sideways directed beam, or for an illumination beam and for a laser light beam, or both.

Applicant also believes there may be a need for a portable light that has a clip that does not significantly extend beyond the outline or envelope of the light when not in use.

Accordingly, a portable light may comprise: a light body including a light head and a light housing extending away from the light head; a first light source supported by the light head; a first actuator for selectively energizing the first light source; a second light source supported by the light head; and a second actuator for selectively energizing the second light source; wherein the second actuator is on the light body substantially diametrically opposite to the first actuator.

In another aspect, the second light source may include: a light emitting diode to produce light directed substantially transversely to a longitudinal axis; or a laser light source energizable to produce light directed substantially along the longitudinal axis.

In another aspect, the light housing may define an envelope line extending along a side thereof and may have a recess inward of the envelope line, and a clip may be disposed substantially in the recess of the light housing.

In another aspect, a portable light may comprise: a light housing extending from a light head and defining an envelope line extending along a side thereof, the light housing having a recess in the side thereof inward of the envelope line; a light source supported by the light head and energizable to produce light; a switch for selectively energizing the light source; and a clip disposed in the recess of the light housing and configured so that the clip is substantially in the recess and substantially within the envelope line of the light housing.

In summarizing the arrangements described and/or claimed herein, a selection of concepts and/or elements and/or steps that are described in the detailed description herein may be made or simplified. Any summary is not intended to identify key features, elements and/or steps, or essential features, elements and/or steps, relating to the claimed subject matter, and so are not intended to be limiting and should not be construed to be limiting of or defining of the scope and breadth of the claimed subject matter.

### BRIEF DESCRIPTION OF THE DRAWING

The detailed description of the preferred embodiment(s) will be more easily and better understood when read in conjunction with the FIGURES of the Drawing which include:

FIG. 1 is a perspective view of an example embodiment of a portable light having a clip viewed from a head end from which light is emitted;

FIG. 2 is another perspective view of an example embodiment of a portable light having a clip viewed from a tail end opposite the head end;

FIG. 3 is a side view of a first and broader side of the example portable light shown in FIGS. 1 and 2;

FIG. 4 is a side view of a second and narrower side thereof wherein the clip is visible;

FIG. 5 is a side view of a fourth and narrower side thereof opposite the clip which includes a side facing lens from which light is emitted;

FIG. 6 is an end view of a first end thereof from which light is emitted;

FIG. 7 is a view of a second end thereof opposite to the first end thereof;

FIG. 8 is an exploded view of the example portable light; and

FIG. 9 is a cross-sectional view of the example portable light taken in a plane that bisects the light body longitudinally, including the clip, an internal electrical power source and other internal elements of the portable light.

FIG. 10 is a cross-sectional view of an example alternative embodiment of a portable light taken in a plane that bisects the light body longitudinally, wherein the alternative example embodiment includes an LED light source, a laser light source, an internal electrical power source and other internal elements of the portable light, and that may include an optional clip; and

FIG. 11 is an electrical schematic diagram of an example embodiment of an electrical circuit for the example portable light of FIG. 9 and/or for the example portable light of FIG. 10.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. Similarly, similar elements or features may be designated by like alphanumeric designations in different figures of the Drawing and with similar nomenclature in the specification. According to common practice, the various features of the drawing are not to scale, and the dimensions of the various features may be arbitrarily expanded or reduced for clarity, and any value stated in any Figure is given by way of example only.

### DESCRIPTION OF THE PREFERRED EMBODIMENT(S)

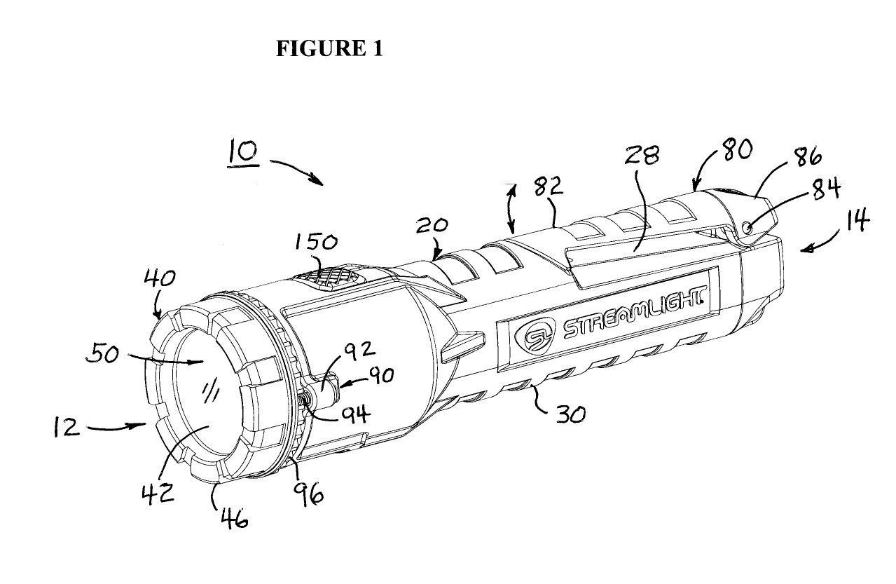

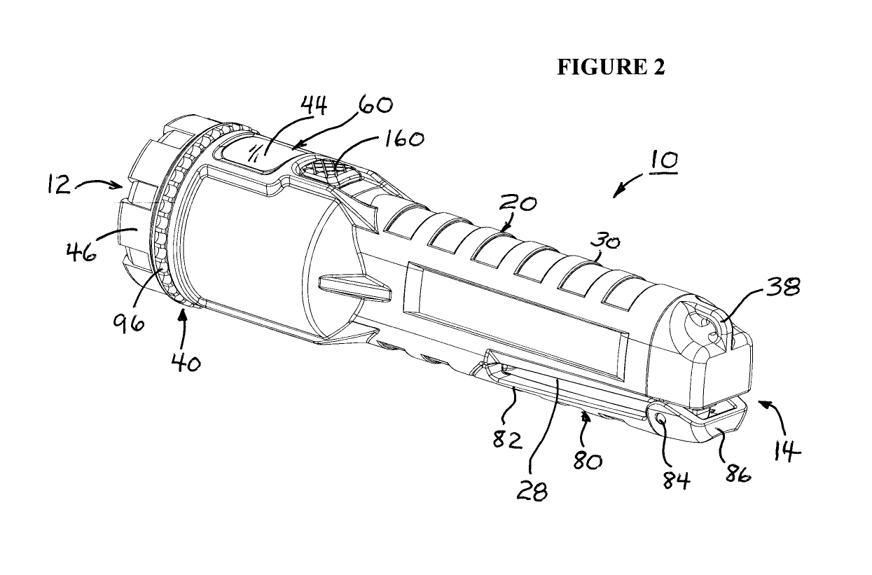

FIG. 1 is a perspective view of an example embodiment of a portable light 10 having a clip 80 viewed from a head end 12 from which light is emitted, and FIG. 2 is another perspective view of an example embodiment of a portable light 10 having a clip 80 viewed from a tail end 14 opposite the head end 12. Portable light 10 has a light body 20 including a light housing 30 to which a light head 40 including one or more light sources 50, 60 is attached at a forward or head end 12 of portable light 10. Light 10 and light housing 20 also have a rear or tail end 14 opposite the head end 12. One or more switch actuators 150, 160 may be provided for selectively energizing the one or more light sources 50, 60 to produce light.

In one example embodiment, portable light 10 has a first light source 50 in head 40 that produces light which is directed substantially axially forward along the longitudinal axis of light 10. Light from light source 50 is emitted axially forwardly through lens 42 of head 40 at head end 12. Additional and optionally, as in the illustrated example embodiment, light 10 also has a second light source 60 that produces light which is directed to the side, e.g., at an angle to the longitudinal axis of light 10, through lens 44 of head 40 which preferably is near to head end 12.

In one preferred arrangement, the light projected forwardly may have a relatively narrow beam angle, e.g., may be a spot beam, and the light projected to the side may have a relatively wider beam angle, e.g., may be a flood beam. The beam directed forward typically is substantially centered on the forward direction of the longitudinal axial axis of light 10 and the light directed to the side typically is centered on an axis that is rotated between about 60° and about more than 90° to the side from the forward direction of the longitudinal axial axis of light 10. In one example portable light 10, a flood beam is directed to the side, e.g., downward, at about 90° off a forwardly directed longitudinal axis.

In the usual orientation in which example portable light 10 would be used, e.g., with the forwardly directed beam directed substantially horizontally forward, e.g., to illuminate areas and objects that are in front of the user, the actuator 150 would be at the top of light 10, and lens 44 and actuator 160 would be downward facing so as to illuminate the surface and objects that are immediately in front of the user. In one preferred embodiment, each of light sources 50, 60 are independently actuatable and controllable by the user so that either one or both of light sources 50, 60 may be selectively operated to provide a forwardly directed spot beam, a sideways (e.g., usually downwardly) directed flood beam, or both.

In one example embodiment, switch actuator 150 which is on the top of head 40 of light 10 when light 10 is used in its usual orientation may be utilized to control operation of light source 50 and the forwardly directed light beam it produces, and switch actuator 160 which is on the bottom of head 40 of light 10 adjacent side lens 44 when light 10 is used in its usual orientation may be utilized to control operation of light source 60 and the sideways directed light beam it produces. Alternatively, and optionally, light 10 may include a controller or other electrical circuitry that is responsive to switch actuators 150 and/or 160 so that either or both switch actuators 150, 160 may be utilized for controlling either or both of light sources 50, 60 and the light selectively produced thereby.

Portable light 10 includes a clip 80 that is pivotably mounted 84 in a recess 28 of light housing 30 near the rearward end 14 thereof. Clip 80 has an elongated member 82 extending forward of the pivot 84 and has a shorter member 86 rearward of pivot 84. Clip 80 is preferably biased 88, e.g., by a spring 88, to pivot towards light housing 30 thereby to either urge the remote end of elongated clip member 82 to bear against light housing 30 (e.g., at the forward end of recess 28 as illustrated) or against an object that is between elongated clip member 82 and light housing 30. Pressing on shorter member 86 causes clip 80 to rotate on pivot 84 such that the remote (forward) end of elongated clip member 82 moves away from light body 20, 30 thereby to create a gap between clip member 82 and light housing 30 where an object to which light 10 is to be attached, e.g., clipped, may be placed. The pivotability of clip 80 is indicated by a double-ended arrow.

Where portable light 10 is intended for use in hazardous environments, light 10 may include a lock arrangement 90 that prevents the removal of lens ring 46, e.g., to gain access the interior of light 10, e.g., to install and/or replace batteries therein, without the use of a tool. Lens ring 46 preferably includes a plurality of raised ridges 96 disposed circumferentially around the outer circumference of lens ring 46, thereby to define a plurality of recesses 96 around the periphery of lens ring 46.

Lock arrangement 90 may include, e.g., a lock support 92 at the forward end of housing 30 that includes a threaded axial opening in which is disposed a threaded lock member 94. When lock member 94 is rotated by a tool in one direction it advances axially forward to engage one of the plural recesses 96 thereby to lock lens ring 46 in its then present position, and when lock member 94 is rotated by a tool in an opposite direction it advances axially rearward to disengage from the plural recesses 96 thereby to enable lens ring 46 to be rotated on housing 30 from its then present position, e.g., to be removed therefrom.

A loop or opening 38 may be provided at the rear of light housing 30, e.g., for receiving a ring, e.g., a split ring, or a lanyard as may be desired, by a user of light 10. Loop 28 may also be utilized to hang light 10 on a pin or hook.

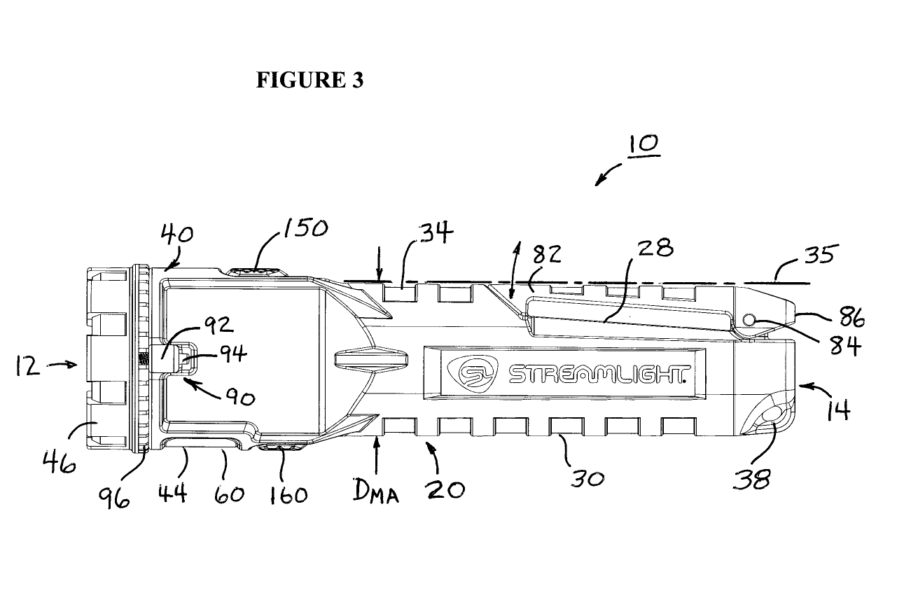

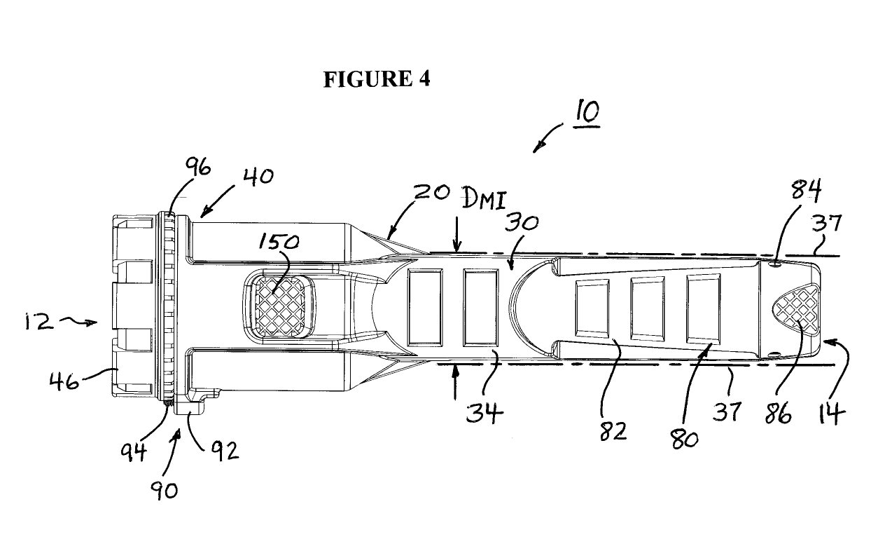

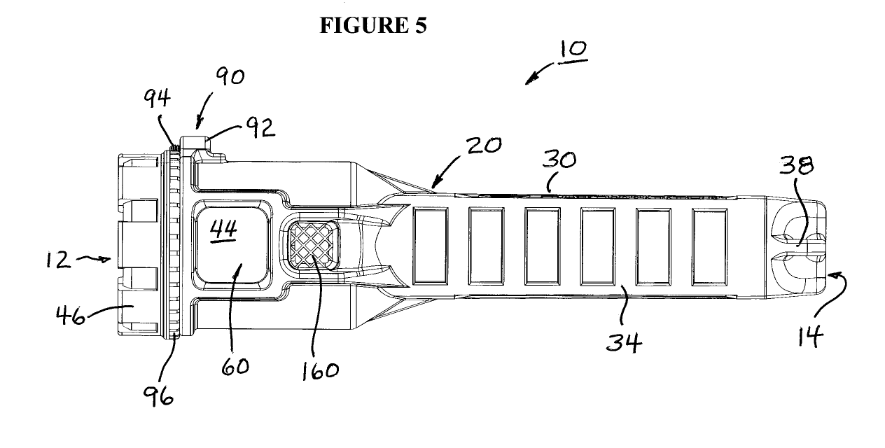

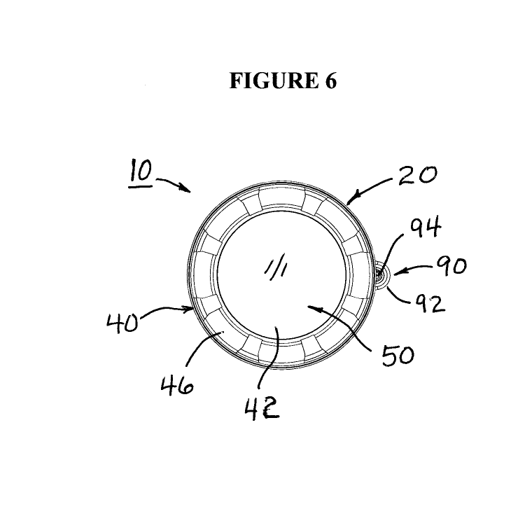

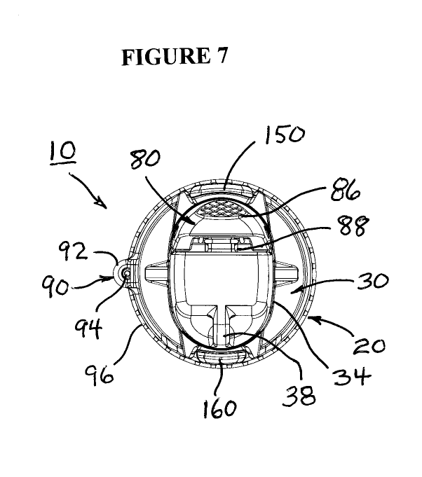

FIG. 3 is a side view of a first and broader side of the example portable light 10 shown in FIGS. 1 and 2; FIG. 4 is a side view of a second and narrower side thereof wherein the clip 80 is visible; FIG. 5 is a side view of a fourth and narrower side thereof opposite the clip 80 which includes a side facing lens 44 from which light is emitted; FIG. 6 is an end view of a first end 12 thereof from which light is emitted via lens 42; and FIG. 7 is an end view of a second end 14 thereof opposite to the first end 12 thereof. A third and also broader side of the example portable light 10, opposite to the first broader side thereof, is substantially a mirror image of the first side thereof, but without lock mechanism 90.

Light housing 20 is substantially cylindrical at its forward or head end 12 and has a substantially oval or elliptical cross-sectional shape along its barrel 34, e.g., from its cylindrical head 40 to its rearward or tail end 14. The oval or elliptical cross-sectional shape of barrel 34 defines a major (or larger) dimension D_{MA} and a minor (or smaller) dimension D_{MI} as indicated in FIGS. 3 and 4. It is noted that light housing 20 may have other shapes and sizes, e.g., head end 30 thereof may be oval or polygonal, e.g., hexagonal or octagonal, and may be larger or smaller or the same size as barrel 34. Similarly, barrel 34 of light housing 20 may have other shapes and sizes, e.g., may be cylindrical, oval or polygonal, e.g., hexagonal or octagonal, and may be larger or smaller or the same size as head 40. It is neither necessary nor preferred that head 40 and barrel 34 have different cross-sectional shapes and/or sizes or that they have the same cross-sectional shape and/or size.

The outer surface of the forward end of barrel 34, at what could be referred to as being the top of light 10, defines a line 35, e.g., at the major dimension D_{MA} thereof, that can be extended rearwardly to end 14 and generally following the envelope or outline thereof. Clip 80 is preferably and substantially, if not completely, within recess 28 and between line 35 and housing 30. If the cross-sectional shape of barrel 34 is symmetrical about the central axis of light 10, then dimensions D_{MA} and D_{MI} may be substantially the same.

Similarly, the outer surface of the forward end of barrel 34, at what could be referred to as being the sides of light 10, defines lines 37, e.g., at the minor dimension D_{MI} thereof, that can be extended rearwardly to end 14 and generally following the envelope or outline thereof. Clip 80 is preferably and substantially, if not completely, within recess 28 and between lines 37 and housing 30.

In the illustrated example embodiment the cross-section of barrel 34 is substantially the same over a substantial part of its length, and lines 35, 37 can be substantially parallel to each other and to the central longitudinal axis of light 10. From a practical standpoint, housing 30 is slightly narrower at rearward end 14, e.g., to provide draft for molding housing 30, and so lines 35, 37 are not truly parallel, but converge slightly. It is not necessary that lines 35, 37 be parallel or substantially parallel to each other or to the center light of light 10, and, e.g., light housing 30 and the envelope thereof could be substantially narrower at rearward end 14 than at the forward end of barrel 34 thereof.

Further, it is not necessary that clip 80 strictly be entirely within line 35 and/or within lines 37, only that clip 80 not extend substantially beyond the envelope or outline of light housing 30 sufficiently or in a manner such that it might easily catch on or snag external objects. For example, a clip 80 extending beyond lines 35 and/or 37 might be shaped where it rests against barrel 34 and recess 28 thereof at a relatively small angle or edge, e.g., as does clip 80 in the illustrated example embodiment, thereby to not present any substantial edge or raised feature, particularly along the sides of light 10, that could easily snag or catch on an external object.

As is visible in FIG. 6, barrel 34 of light housing 30 of the illustrated embodiment is seen to have a substantially oval or elliptical cross-sectional shape and clip 80 is seen to be substantially within that oval or elliptical outline, as is preferred, but is not strictly necessary.

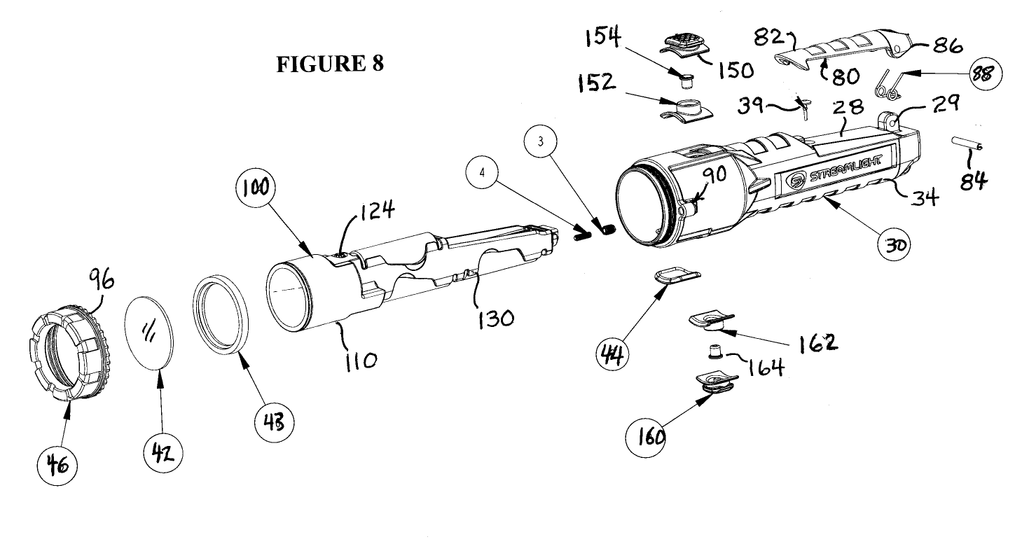

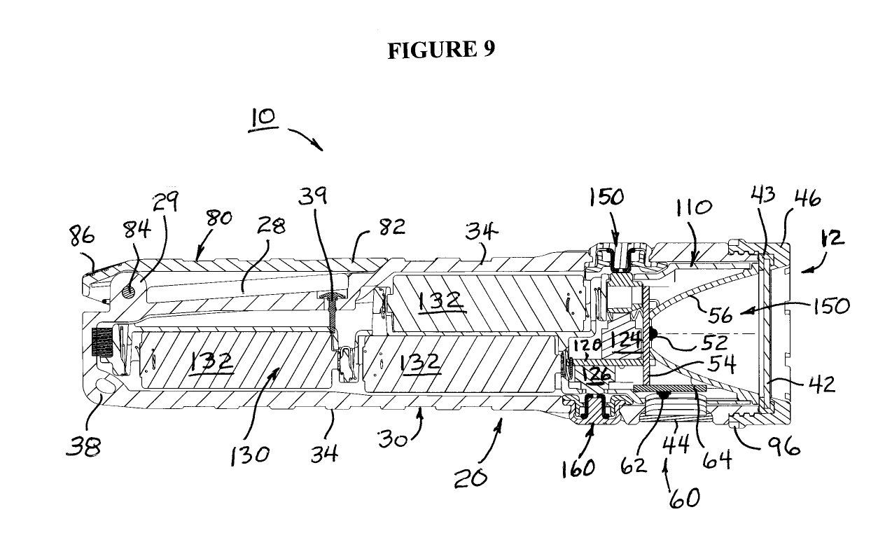

FIG. 8 is an exploded view of the example portable light 10; and FIG. 9 is a cross-sectional view thereof taken in a plane that bisects the light body 20 longitudinally, including the clip 80, an internal assembly 100 including an electrical power source 130 and other internal elements of the portable light 10. Structure and features described above are not repeated here. Light housing 30 is seen to have a threaded forward end (with external threads) onto which lens ring 46, which has internal threads, threadingly attaches, to hold lens 42 against the forward end of light housing 30. Optionally, but preferably, a circular seal 43 is disposed between the rear surface of lens 42 and the forward end of housing 30. Seal 43 may be an O-ring or may be a shaped circular seal having, e.g., an annular recess for receiving the periphery of lens 42 as illustrated.

At the rear end 14 of housing 30, extending from recess 28, is a base 29 which has a transverse opening for receiving a pivot pin 84 of clip 80. Biasing member 88, e.g., a spring 88, has one of more loops through which pivot pin 84 passes with one loop of spring 88 on each side of base 29. A link of spring 88 between the two loops bears against housing 30 and two prongs thereof bear against the rearward extension 86 of clip 80, thereby to bias rearward extension 86 away from housing 30 and due to the pivot action of pin 84, to bias the distal end of elongated clip member 82 to bear against the forward end of recess 28 of housing 30, whereby clip 82 can clip an object between its end 82 and housing 30.

Switch actuator 150 includes an actuator boot 150 and a retainer 152 to clamp boot 150 adjacent to housing 30, and preferably provide a seal thereat. Switch actuator 150 also includes a hollow cylindrical support or plunger 154 for transmitting pressure applied to actuator boot 150 inward to an electrical switch 124 which is mounted on a first side of printed circuit board 120 within switch module 110 of internal assembly 100.

Switch actuator 160 includes an actuator boot 160 and a retainer 162 to clamp boot 160 adjacent to housing 30, and preferably provide a seal thereat. Switch actuator 160 also includes a hollow cylindrical support or plunger 164 for transmitting pressure applied to actuator boot 160 inward to an electrical switch 126 which is mounted on a second side of printed circuit board 120 within switch module 110 of internal assembly 100.

It is noted that actuator 150 is located on the same side of light 10 as is clip 80, and that actuator 160 is located on the side of light 10 that is opposite to clip 80. Thus, when light 10 is carried on an object, e.g., by being clipped by clip 80 to an object, e.g., to a person's belt or clothing or to a tool carrier, actuator 160 is exposed and may easily be actuated, e.g., by being pressed towards the object or person, to illuminate the transversely directed light source 60 which, with light 10 hanging generally vertically, will provide a beam of light directed outwardly from the person.

Internal assembly 100 is shaped and sized to be inserted into light housing 30 from the opening at the cylindrical forward end thereof. Assembly 100 includes a cylindrical switch module 110 at the forward end thereof and a battery holder 130 extending rearwardly therefrom. Battery holder 130 tapers in transverse dimension, e.g., top to bottom, and being narrower at the rearward end thereof, thereby to fit within the narrower rearward end of barrel 34 of housing 30.

Switch module 110 includes an electrical circuit for controlling operation of light sources 50, 60 and light sources 50, 60. The electrical circuit includes two switches 124, 126 that are actuatable via switch actuators 150, 160, respectively, for selectively energizing one or both of light sources 50, 60 in accordance with the electrical circuit and controls of light 10. Switches 124, 126 are supported by printed circuit board 120.

Light source 50 includes a light emitting diode (LED) 52 mounted on a transversely positioned circuit board 54 adjacent an opening at the narrow end of reflector 56. Reflector 56 has a curved light reflecting surface, e.g., a parabolic or other shaped surface, and opens to a wider end adjacent to lens 42, thereby to form and direct light from LED 52 forwardly through lens 42 and in a general forward direction substantially along the central longitudinal axis of portable light 10. Preferably, reflector 56 forms light produced by LED 52 into a substantially relatively narrow or spot beam.

Light source 60 includes a light emitting diode (LED) 62 mounted on an axially positioned circuit board 64 adjacent an opening in which side lens 44 is disposed. Light source 60 does not have a reflector so that the light produced by LED 62 opens to a wider beam, thereby to form and direct light from LED 62 through lens 44 and in a general sideways or radial direction from portable light 10. Preferably, LED 62 and lens 44 forms light produced by LED 62 into a substantially relatively wider or flood beam.

Battery holder 130 includes a carrier that receives and supports a source of electrical power 132, e.g., a carrier preferably having one or more receptacles for receiving one or more batteries 132. Receptacles for batteries 132 are preferably configured to receive plural batteries 132 side by side at the end thereof close to switch module 110 and a lesser number of batteries side by side at the distal end thereof.

In the illustrated embodiment, battery holder or carrier 130 supports a single battery 132 at the distal end thereof and supports two batteries 132 in side by side arrangement in the forward end thereof. This configuration provides for three batteries 132 which can be electrically connected in series by electrical conductors of carrier 130 to provide sufficient voltage for electrically powering first and second light emitting diode (LED) light sources 52, 62. Two batteries 132 are disposed side by side within the oval or elliptically shaped cross-section of the forward end of barrel 34 and the single battery 132 fits within the narrowed, e.g., approximately a partial oval cross-sectional, shape of the rearward end of barrel 34. As a result, barrel 34 of housing 30 can be configured to provide a sufficiently large recess 28 at the rearward end 14 of light 10 to receive a clip 80 of sufficient size to support light 10, with clip 80 not extending beyond the envelope of light housing 30 sufficiently to become caught on of snagged on an external object.

Alternatively, battery holder 130 may be considered as supporting two batteries 132 in end to end arrangement in the portion thereof, e.g., a lower portion, that is disposed to extend into the narrower rearward end of housing 30, e.g., adjacent to recess 28 and clip 80, and to support a single battery 132 in the forward upper part thereof that is forward of recess 28 and clip 80 and side by side with the forward battery 132 of the two batteries 132 that are in end to end arrangement.

Housing 30 also has an opening, e.g., an opening in the wall between recess 28 and the interior cavity of barrel 34, in which resides a resilient plug 39 that serves as a valve to, e.g., relieve any pressure that may occur within portable light 10.

Internal assembly 100 may have a closed-cell foam pad or other resilient member at the distal end of battery holder 130 thereof for absorbing shock and/or adjusting for tolerances and/or gaps. Housing 30 may have a threaded insert in the lock support 92 thereof into which is threaded a set screw 94 that serves as a lock member 94 for engaging the plural recesses 96 around the periphery of lens ring 46. Switch module and battery holder 130 typically include metal clips, springs and other conductors for providing electrically conductive paths among LEDs 52, 62, batteries 132, and circuit board 120 as may be needed for operating portable light 10, and circuit board 120 typically includes in addition to switches 124, 126, various resistors and other electronic parts as may be needed for operating LEDs 52, 62 in a desired manner. Typically, LEDs 52, 62 each may be controlled by switches 124, 126 to operate in at least continuous ON and OFF states, and preferably at least in a momentary ON state.

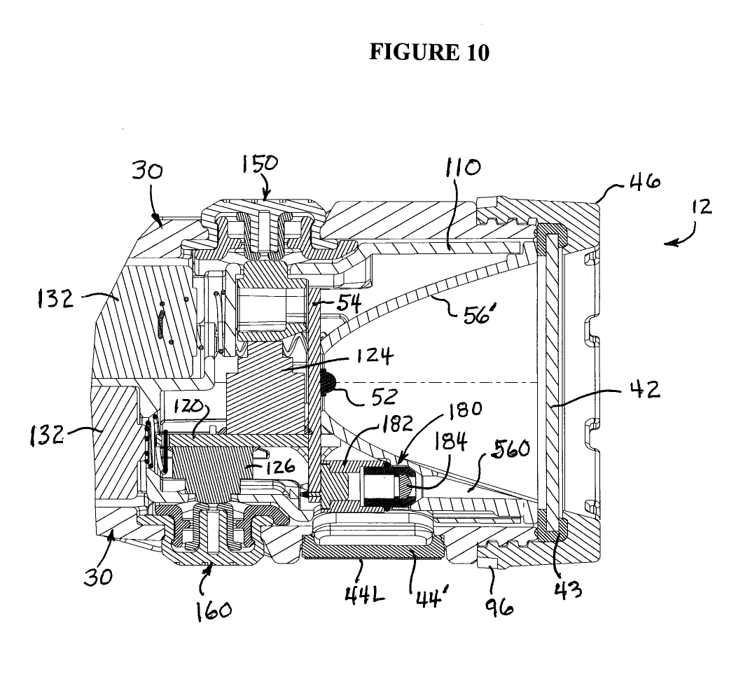

FIG. 10 is a cross-sectional view of an example alternative embodiment of a portable light 10′ taken in a plane that bisects the light body 20, 30 longitudinally, wherein the alternative example embodiment 10′ includes an LED light source 52, a laser light source 180, an internal electrical power source 132 and other internal elements of the portable light, and that may include an optional clip 80. The arrangement of the alternative embodiment of portable light 10′ is in many respects substantially the same as that of portable light 10 described above, e.g., in relation to FIGS. 1-9, and so the description thereof that is substantially the same is not repeated here.

As in portable light 10, portable light 10′ preferably includes an illumination light source 50 that directs light forwardly from light end 12, preferably in a relative narrow angle or spot beam, in a direction generally parallel to the longitudinal axis of light 10′. In portable light 10′, however, the light source 60 of light 10 which directs illumination light through lens 44 in a generally transverse direction relative to light body 20, 30 is not present, and a laser light source 180 that directs a laser light beam forwardly, e.g., in a direction generally parallel to the illumination light beam provided by light source 50, 52, is provided. The laser light source 180 is preferably disposed behind reflector 56′ and its laser beam is directed through an opening 560 provided in reflector 56′ and thence outward through lens 42 at the forward end 12 of light 10′.

Laser light source 180 is supported by the circuit board 54 that also supports the LED 52 which provides an illumination light source 50 that preferably directs light forwardly through lens 42, e.g., in a relatively narrow or spot beam shaped by the curved inner surface of reflector 56′ as described above in relation to reflector 56. Laser light source 180 is preferably a laser cartridge having a housing 182, e.g., a cylindrical housing, that is disposed in a space behind reflector 56′ and aligned to project a laser beam through opening 560 in reflector 56′. Optionally, but preferably, a resilient or cushioning member 181, e.g., an O-ring 184, surrounds the housing 182 of laser cartridge 180 between a shoulder thereof and a circular recess or groove in the rear surface of reflector 56′. Resilient or cushioning member 181 tends to cushion laser source 180 against shock, e.g., as when the light 10′ is dropped or bangs against an object.

Lens 44′ may be the same as the lens 44 employed in light 10, but need not be transparent where light is not directed through lens 44′, e.g., in the embodiment of light 10′. In one embodiment, lens 44′ is the lens 44 with a cover 44L applied thereto, and the cover 44L is preferably a label indicating that light 10′ includes a laser light source 180. Label 44L may provide, e.g., suitable cautions and/or warnings regarding the laser light. Alternatively, lens 44′ may be a cover 44′.

Portable light 10′ includes two independent light sources 50 and 180 similarly to portable light 10 which includes two independent light sources 50 and 60, and each light source is selectively energizable by a particular actuator 150, 160, located on the exterior of light body 20. Preferably, light source 50 is selectively actuatable by actuator 150 which is located on the top of the forward portion of light body 20, and laser light source 180 is selectively actuatable by actuator 160 which is located on the bottom of the forward portion of light body 20, with light 10, 10′ in a relatively horizontal orientation in which it is commonly utilized.

This light 10′ configuration is similar to the configuration of portable light 10 described above wherein light source 50 preferably is selectively actuatable by actuator 150 located at the top of light body 20 and light source 60 preferably is selectively actuatable by actuator 160 located on the bottom side thereof, with both actuators 50, 60 preferably being located on the forward half of light 10, 10′.

As a result, each of the two independent light sources 50, 60 of light 10 and 50, 180 of light 10′ is independently actuatable by an actuator 150, 160 that is located substantially diametrically opposite the other actuator 160, 150 radially on light body 20 This configuration wherein a particular actuator in a particular location on the light is associated with a particular light source serves to avoid any ambiguity that might result if the two actuators 150, 160 were to be located relatively closely to each other, e.g., at similar radial positions on light body 20, and not in distinctively different locations.

It is noted that actuator 150 is located on the same side of light 10′ as is clip 80, and that actuator 160 is located on the side of light 10′ that is opposite to clip 80. Thus, when light 10′ is carried, e.g., is clipped by clip 80 to an object, e.g., to a person's belt or clothing or a tool carrier, actuator 160 is exposed and may easily be actuated, e.g., by being pressed towards the object or person. If light 10′ is supported by clip 80 in a generally horizontal orientation, then actuating actuator 160 controls laser light source 180 to provide laser light in the generally horizontal direction.

Both of actuators 150, 160 are preferably located forward of the longitudinal midpoint of light 10, 10′, e.g., closer to the forward end 12 than to the tail or rearward end 14 thereof, so that they are in a comfortable position for actuation by a user's thumb and finger when a user grasps the body 20 of light 10, 10′ somewhere in the vicinity of its center of mass or balance point when the light is held in a horizontal orientation. In the illustrated embodiment, actuators 150, 160 are approximately one-third of the length of light 10, 10′ rearward from the forward end 12 thereof or are slightly forward of that location, with the actuator 160 for transverse light source 60 or laser light source 180 being slightly farther forward than is actuator 150 for forwardly directed light source 50.

The safety lock arrangement 90 which prevents the head 40 of light 10, 10′ to be removed from the body 20 thereof without the use of a tool to release lock mechanism 90 is typical of lights that are intended and/or certified, e.g., under UL standards, for use in hazardous locations and/or environments. In addition, Applicant is not aware of any commercially available light that, like light 10′, includes both an illumination light source 50 and a laser light source 180, and that is rated for use in a hazardous location and/or environment.

Preferably, actuator 150 is slightly closer to the forward end 12 of light 10, 10′ than is actuator 160, and actuator 160 is slight rearward of actuator 150 thereby to provide a natural and comfortable gripping position with a user's fingers wrapped around the body 20 of light 10, 10′ with the thumb conveniently close to actuator 150 and a finger, e.g., the forefinger or middle finger, conveniently close to actuator 160. Thus, a user is thought to be able to easily and quickly acclimate to holding light 10, 10′ in a manner convenient for actuating the top actuator 150 with the thumb to selectively energize light source 50 and for actuating the bottom actuator 160 with the forefinger to selectively energize light source 60, 180.

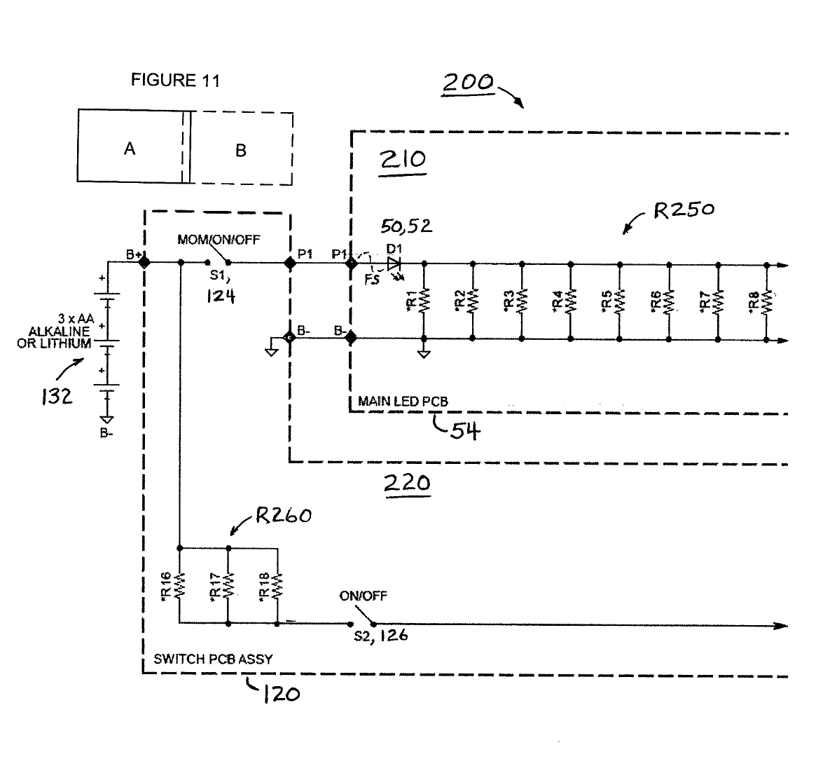

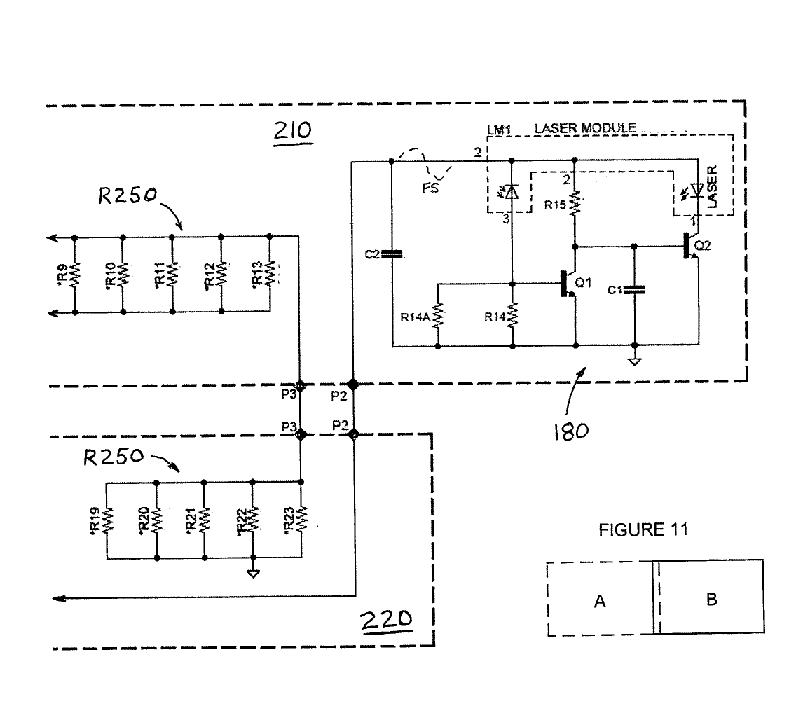

FIG. 11 is an electrical schematic diagram of an example embodiment of an electrical circuit 200 for the example portable light 10 of FIG. 9 and/or for the example portable light 10′ of FIG. 10. Electrical circuit 200 illustrated therein preferably includes electronic components that are mounted to one or more circuit boards, e.g., to a main circuit board 54, 210 and to a switch circuit board 120, 220, as may be preferred where light 10, 10′ is intended to be intrinsically safe for use in a hazardous location and/or environment.

Electrical power source 132, e.g., plural batteries 132 connected in series, is coupled to switch circuit board 120, 220 to which are mounted an electrical switch S1, 124 for selectively energizing LED D1, 52 of light source 50 and an electrical switch S2, 126 for selectively energizing LED 62 of light source 60 in the case of light 10 and laser light source 180 in the case of light 10′.

In the simplest instance, the current flowing through LED D1, 50 is determined by the resistance R250 which provided by the series combination of parallel-connected resistors R1-R13 and of parallel-connected resistors R19-R23. The resistance and power dissipation ratings of these resistors R1-R13 and R19-R23 are selected to provide an adequate current to operate LED D1, 52 to produce a desired level of brightness while also limiting the maximum “fault” current that could flow should LED D1, 52 fail in a short circuit mode. Similar resistive current control and power limiting circuitry is used for light source 60, 62 of light 10.

Alternatively, and/or additionally, such protection against excessive power dissipation and temperature may be provided by employing a fuse, which is a resistor that is configured to fail in an open-circuit mode when too much current flows through it, e.g., as a series part of the resistance that limits current. For example, a fuse FS could be placed in series with LED D1 on circuit board 210 and/or in series with laser module LM1 on circuit board 210, or in series with switch S1, 124 and/or switch S2, 126 on circuit board 220. If one or more fuses FS are provided, it is preferred that a separate fuse FS be provided in each of the series circuits that supply electrical power to each of light source 50 and light source 60 or laser source 180.

In the instance of laser light source LM1, 180 of light 10′ the laser module LM1 includes a laser diode LASER (connected between terminals 2 and 1 of module LM1) that produces laser light in response to the current flowing through it and a photo diode (connected between terminals 2 and 3 of module LM1) that produces a current in response to the light impinging upon it, e.g., the light produced by laser diode LASER, all within laser module LM1. Under a failure condition, e.g., a short circuit of laser module LM1, the current flowing through laser module 180, LM1 is limited by the resistance 8260 of parallel-connected resistors R16-R18.

Laser light source 180 includes a control circuit provided by transistors Q1, Q2 and their associated electronic components. Transistor Q2 which is in series with laser diode LASER receives drive current when switch S2, 126 is closed to apply voltage to resistor R15 through which drive current is applied to the base of transistor Q2, thereby to turn transistor Q2 on and to cause current to flow through laser diode LASER which then produces laser light. That laser light impinges within module LM1 upon the photo-diode of module LM1 which applies drive current to the base of transistor Q1 in a negative feedback sense tending to turn transistor Q1 on which in turn divert base current from transistor Q2 to tend to turn transistor Q2 off thereby to reduce the current flowing through the laser diode LASER. As a result, an equilibrium is reached whereat the current flowing through laser diode LASER is stabilized for controlling the laser light output of laser module LM1

Resistor R15 and capacitor C1 form a low pass filter which slows the turning on and off of transistor Q2 thereby to help stabilize the negative feedback control circuit of transistors Q1, Q2 and equilibrium current as described. Capacitor C2 provides filtering.

In each of the foregoing electrical circuits, plural resistors R250, R260 are provided in parallel so as to limit the current that can flow and the power dissipation, and to physically spread the heat dissipated therein over an area of circuit boards 210, 220. In addition, circuit boards 54, 210 and 120, 220 preferably have thermally conductive features, such as areas of copper other than or larger than that necessary for providing electrical connections, that assist to spread heat, e.g., heat from resistances 8250, 8260, across a greater portion thereof. This arrangement tends to limit the temperature rise thereof from increasing above a safe temperature, e.g., generally a temperature less than about 135° C. for temperature code T4, under any expected operating condition and under certain unusual conditions, e.g., conditions as specified in an applicable safety standard, e.g., Underwriter's Laboratory standard UL913 or ATEX standard EN60079-0 or IEC standard IEC 60079-0 which are for devices that are to be used in hazardous locations and/or environments. This sort of arrangement is often referred to as being “intrinsically safe” because of the limited maximum temperature that can occur even under prescribed fault and over-stress conditions.

Thus, the foregoing combination of features of portable light 10, 10′ and of its locking mechanism 90, light sources 50, 60, 180, actuator 150, 160 configuration, and its internal circuitry 200, provide a portable light 10, 10′ that is convenient and easy to use, that may be configured to be intrinsically safe, and/or that can qualify for safety ratings for use in hazardous locations and/or environments.

In one typical example embodiment, portable light 10 is about 7 inches (about 17.8 cm) in length, head 40 thereof is about 1.8 inches (about 4.6 cm) in diameter, and dimensions D_{MA} and D_{MI} of barrel 34 are about 1.5 inches (about 3.8 cm) and about 1.05 inches (about 2.7 cm), respectively.

By way of example, housing 30, lens ring 46, clip 80 and internal assembly 100 including switch module 110 and battery holder 130, are preferably molded, and may be of nylon, engineered nylon, ABS plastic, polycarbonate, or any other suitable plastic or other moldable material. Switch actuator members 150, 152, 160, 164 and valve 39 may be of rubber, synthetic rubber, silicone, or any other suitable elastomeric or resilient material. Lenses 42, 44 may be of glass, polycarbonate, or any other optically transparent material. Batteries 132 may be of any suitable size and type, and in one preferred embodiment, three size AA alkaline or lithium batteries 132 are employed.

A portable light 10 may comprise: a light body 20 defining a longitudinal axis and including a light head 40 at a first end 12 thereof and a light housing 30 extending away from the light head 40; the light housing 30 having an internal cavity for receiving a source of electrical power; a first light source 50 supported by the light head 40 and energizable to produce light directed outwardly from the light head 40 substantially along the longitudinal axis; a first actuator 50 at a first location on a half of the light body 20 proximate the first end 12 for selectively energizing the first light source 50 to produce light; a second light source 60, 180 supported by the light head 40 and energizable to produce light directed outwardly from the light head 40; a second actuator 160 at a second location on the half of the light body 20 proximate the first end 12 for selectively energizing the second light source 60, 180 to produce light, wherein the second actuator 160 is supported on the light body 20 substantially diametrically opposite to the first actuator 50. The second light source 60, 180 may include: a light emitting diode 60, 62 energizable to produce light directed substantially transversely to the longitudinal axis; or a laser light source 180 energizable to produce light directed outwardly from the light head 40 substantially along the longitudinal axis. The light body 20 may have an opening through which light produced by the second light source 60, 180 passes in a direction substantially transverse to the longitudinal axis, and the second actuator 160 may be supported on the light body 20 adjacent to the opening in the light body 20 for the light produced by the second light source. The portable light 10 may further comprise a lens 44 in the opening in the light body 20. wherein the second actuator 160 is supported on the light body 20 immediately rearward of the lens 44. The portable light 10 may further comprise a cover 44, 44′, wherein the light body 20 may have an opening in a side thereof in which the cover 44, 44′ is disposed, wherein: if the second light source 60, 180 includes a light emitting diode 62 energizable to produce light directed substantially transversely to the longitudinal axis, then the cover 44, 44′ disposed in the opening may be a lens 44 through which light produced by the light emitting diode 60, 62 passes in a direction substantially transverse to the longitudinal axis; or if the second light source 60, 180 includes a laser light source 180 energizable to produce light directed outwardly from the light head 40 substantially along the longitudinal axis, then the cover 44, 44′ disposed in the opening provides a notice regarding the laser light source 180. The light housing 30 may define an envelope line 35, 37 extending along a side thereof away from the light head 40 along a side of the light housing 30, the light housing 30 having a recess 28 in the side thereof inward of the envelope line 35; and the portable light 10 may further comprise: a clip 80 disposed in the recess of the light housing 30, wherein the shape and size of the recess and the shape and size of the clip 80 are configured so that the clip 80 is substantially in the recess 28 and substantially within the envelope line 35, 37 of the light housing 30, whereby the clip 80 does not extend substantially beyond the envelope 35, 37 of the portable light 10 where it could catch on or snag an external object. The clip 80 may be pivotable relative to the light housing 30; or the clip 80 may be biased to pivot towards the light housing 30; or the clip 80 may be proximate an end 14 of the light housing 30 distal the light head 40; or the clip 80 may be located on a side of the light body 20 opposite to a side of the light body 20 that supports the second actuator 160; or any combination of the foregoing. The source of electrical power 130, 132 may include plural sources of electrical power 130, 132, and the internal cavity may be configured to receive fewer of the plural sources of electrical power 130, 132 in side by side arrangement in a first location in the cavity adjacent the recess 28 than at another location in the cavity. The first light source 50 may produce a spot beam and the second light source may produce a flood beam. The first actuator 50 may actuate a first electrical switch 124 for selectively energizing the first light source 50 and the second actuator 160 may actuate a second electrical switch 126 for selectively energizing the second light source 60, 180. The portable light 10 may further comprise a first resistance 250 in series with the first light source 50 and a second resistance 260 in series with the second light source 60, 180, wherein: the first resistance 250 and the second resistance 260 may each have a respective ohmic value to render the portable light 10 intrinsically safe; or the first resistance 250 and the second resistance 260 may each include a fuse FS, or the first resistance 250 and the second resistance 260 may each include a fuse FS and have a respective ohmic value to render the portable light 10 intrinsically safe.

A portable light 10 may comprise: a light body 20 defining a longitudinal axis and including a light head 40 at a first end 12 thereof and a light housing 30 extending away from the light head 40; the light housing 30 having an internal cavity for receiving a source of electrical power 130, 132; a first light source 50 supported by the light head 40 and energizable to produce light directed outwardly substantially along the longitudinal axis; a first actuator 50 for selectively energizing the first light source 50 to produce light; a second light source 60 supported by the light head 40 and energizable to produce light directed outwardly substantially transversely to the longitudinal axis through an opening in the light body 20; a second actuator 160 for selectively energizing the second light source 60 to produce light, wherein the second actuator 160 is supported on the light body 20 adjacent to the opening in the light body 20 for light produced by the second light source 60; and wherein the first actuator 50 is supported on the light body 20 substantially diametrically opposite to the second actuator 160. The second light source 60 may include: a light emitting diode 62 energizable to produce the light directed substantially transversely to the longitudinal axis. The second actuator 160 may be supported on the light body 20 adjacent to the opening in the light body 20 for the light produced by the second light source 60. The portable light 10 may further comprise a lens 44, 44′ in the opening in the light body 20 through which the light produced by the second light source 60 passes in a direction substantially transverse to the longitudinal axis. The light housing 30 may define an envelope line 35, 37 extending along a side thereof away from the light head 40 along a side of the light housing 30, the light housing 30 having a recess 28 in the side thereof inward of the envelope line 35, 37; the portable light 10 may further comprise: a clip 80 disposed in the recess 28 of the light housing 30, wherein the shape and size of the recess 28 and the shape and size of the clip 80 are configured so that the clip 80 is substantially in the recess 28 and substantially within the envelope line 35, 37 of the light housing 30, whereby the clip 80 does not extend substantially beyond the envelope 35, 37 of the portable light 10 where it could catch on or snag an external object. The clip 80 may be pivotable relative to the light housing 30; or the clip 80 may be biased to pivot towards the light housing 30; or the clip 80 may be proximate an end of the light housing 30 distal the light head 40; or the clip 80 may be located on a side of the light body 20 opposite to a side of the light body 20 that supports the second actuator 160; or any combination of the foregoing. The source of electrical power 130, 132 may include plural sources of electrical power 130, 132, and the internal cavity may be configured to receive fewer of the plural sources of electrical power 130, 132 in side by side arrangement in a first location in the cavity adjacent the recess 28 than at another location in the cavity. The first light source 50 may produce a spot beam and the second light source may produce a flood beam. The first actuator 50 may actuate a first electrical switch 124 for selectively energizing the first light source 50 and the second actuator 160 may actuate a second electrical switch 126 for selectively energizing the second light source 60. The portable light 10 may further comprise a lens 44, 44′ in the opening in the light body 20. wherein the second actuator 160 is supported on the light body 20 immediately rearward of the lens 44, 44′. The portable light 10 may further comprise a first resistance 250 in series with the first light source 50 and a second resistance 260 in series with the second light source 60, wherein: the first resistance 250 and the second resistance 260 may each have a respective ohmic value to render the portable light 10 intrinsically safe; or the first resistance 250 and the second resistance 260 may each include a fuse, or the first resistance 250 and the second resistance 260 may each include a fuse FS and have a respective ohmic value to render the portable light 10 intrinsically safe.

A portable light 10 may comprise: a light body 20 defining a longitudinal axis and including a light head 40 at a first end 12 thereof and a light housing 30 extending away from the light head 40; the light housing 30 having an internal cavity for receiving a source of electrical power 130, 132; a first light source 50 supported by the light head 40 and energizable to produce light directed outwardly substantially along the longitudinal axis; a first actuator 50 supported by the light body 20 for selectively energizing the first light source 50 to produce light; a laser light source 180 supported by the light head 40 and energizable to produce light directed outwardly substantially along the longitudinal axis; a second actuator 160 supported by the light body 20 for selectively energizing the laser light source 180 to produce light, wherein the second actuator 160 is supported on the light body 20 substantially diametrically opposite to the first actuator 50. The light body 20 may have an opening in a side thereof in which may be disposed a cover 44, 44′ providing a notice regarding the laser light source 180. The second actuator 160 may be supported on the light body 20 immediately rearward of the cover 44, 44′. The light housing 30 may define an envelope line 35, 37 extending along a side thereof away from the light head 40 along a side of the light housing 30, the light housing 30 having a recess 28 in the side thereof inward of the envelope line 35, 37; and the portable light 10 may further comprise: a clip 80 disposed in the recess 28 of the light housing 30, wherein the shape and size of the recess 28 and the shape and size of the clip 80 are configured so that the clip 80 is substantially in the recess 28 and substantially within the envelope line 35, 37 of the light housing 30, whereby the clip 80 does not extend substantially beyond the envelope 35, 37 of the portable light 10 where it could catch on or snag an external object. The clip 80 may be pivotable relative to the light housing 30; or the clip 80 may be biased to pivot towards the light housing 30; or the clip 80 may be proximate an end of the light housing 30 distal the light head 40; or the clip 80 may be located on a side of the light body 20 opposite to a side of the light body 20 that supports the second actuator 160; or any combination of the foregoing. The source of electrical power 130, 132 may include plural sources of electrical power 130, 132, and wherein the internal cavity is configured to receive fewer of the plural sources of electrical power 130, 132 in side by side arrangement in a first location in the cavity adjacent the recess 28 than at another location in the cavity. The first actuator 50 may actuate a first electrical switch 124 for selectively energizing the first light source 50 and the second actuator 160 may actuate a second electrical switch 126 for selectively energizing the laser light source 180. The portable light 10 may further comprise a first resistance 250 in series with the first light source 50 and a second resistance 260 in series with the laser light source 180, wherein: the first resistance 250 and the second resistance 260 may each have a respective ohmic value to render the portable light 10 intrinsically safe; or the first resistance 250 and the second resistance 260 may each include a fuse FS, or the first resistance 250 and the second resistance 260 may each include a fuse FS and have a respective ohmic value to render the portable light 10 intrinsically safe.

A portable light 10 may comprise: a light body 20 including a light head 40 and a light housing 30 extending from the light head 40, the light housing 30 defining an envelope line extending along a side thereof away from the light head 40 along a side of the light housing 30, the light housing 30 having a recess 28 in the side thereof inward of the envelope line; a light source 50, 60 supported by the light head 40 and energizable to produce light; a switch 124, 126, 150, 160 for selectively energizing the light source 50, 60 to produce light; and a clip 80 disposed in the recess 28 of the light housing 30, wherein the shape and size of the recess 28 and the shape and size of the clip 80 are configured so that the clip 80 is substantially in the recess 28 and substantially within the envelope line of the light housing 30, whereby the clip 80 does not extend substantially beyond the envelope of the portable light 10 where it could catch on or snag an external object. The light housing 30 may have an internal cavity for receiving plural sources of electrical power 132, wherein the cavity is configured to receive fewer of the plural sources of electrical power 132 in side by side arrangement in a location adjacent to the recess 28 than at another location in the cavity. The clip 80 may be pivotable relative to the light housing 30; or the clip 80 may be biased to pivot towards the light housing 30; or the clip 80 may be proximate an end of the light housing 30 distal the light head 40; or the clip 80 may be pivotable relative to the light housing 30 and may be biased to pivot towards the light housing 30; or the clip 80 may be proximate an end of the light housing 30 distal the light head 40, may be pivotable relative to the light housing 30 and may be biased to pivot towards the light housing 30. The light housing 30 may include a pivot base 29 extending from the recess 28 thereof, the pivot base 29 supporting a pivot pin 84 on which the clip 80 pivots. The portable light 10 may further include a biasing member 88 biasing the clip 80 to pivot on the pivot pin 84 towards the light housing 30. The portable light 10 may further comprise: an internal assembly 100 including a battery holder 130 or may comprise a battery holder 130, the battery holder 130 extending into the cavity of the light housing 30 for supporting a plurality of sources of electrical power 132, wherein the battery holder 130 supports fewer of the plural sources of electrical power 132 in side by side arrangement in a location adjacent to the recess 28 than at another location in the cavity. The switch 124, 126, 150, 160 may include one or more switch actuators 150, 160, and a switch module 110 interior the light body 20, the switch module 110 including one or more electrical switches 124, 126 positioned adjacent the one or more switch actuators 150, 160 for being actuated thereby. The light source 50, 60 may include a first light source 50, supported in the light head 40 of the light body 20, the first light source 50, 60 including a reflector 56 for directing light produced by the first light source 50, outwardly substantially along a central longitudinal axis of the light body 20. The switch 124, 126, 150, 160 may comprise a switch actuator 150, 160 on the light body 20 between the light head 40 thereof and the clip 80, wherein the switch actuator 150, 160 actuates an electrical switch 124, 126, for selectively energizing the first light source 50, 60. The portable light 10 wherein the light source 50, 60 may include a second light source 60 supported in the light head 40 of the light body 20, the second light source 60 directing light outwardly substantially transversely to the central longitudinal axis of the light body 20. The switch 124, 126, 150, 160 may comprise a switch actuator 160 adjacent a lens on a side of the light body 20 through which light from the second light source 60 is directed, wherein the switch actuator 160 actuates an electrical switch 124, 126, for selectively energizing the second light source 60. The first light source 50, may produce a spot beam and the second light source 60 may produce a flood beam. The light source 50, 60, 180 may include a laser light source 180 supported in the light head 40, the laser light source 180 directing light outwardly substantially along the central longitudinal axis of the light body. The switch 124, 126, 150, 160 may comprise: a first switch actuator 150 on said light body between the light head 40 thereof and the clip 80, wherein the first switch actuator 150 actuates an electrical switch 124 for selectively energizing the first light source 50; and a second switch actuator 160 on the light body 20 in a location substantially diametrically opposite to the first switch actuator 150, wherein the second switch actuator 160 actuates a second electrical switch 126 for selectively energizing the laser light source 180.

A portable light 10 may comprise: a light body 20 including a light head 40 and a light housing 30 extending from the light head 40, the light housing 30 defining an envelope line extending along a side thereof away from the light head 40 along a side of the light housing 30, the light housing 30 having a recess 28 in the side proximate an end thereof distal the light head 40 and inward of the envelope line; a light source 50, 60 supported by the light head 40 and energizable to produce light; a switch 124, 126, 150, 160 for selectively energizing the light source 50, 60 to produce light; and a clip 80 disposed in the recess 28 of the light housing 30, wherein the shape and size of the recess 28 and the shape and size of the clip 80 are configured so that the clip 80 is substantially in the recess 28 and substantially within the envelope line of the light housing 30, whereby the clip 80 does not extend substantially beyond the envelope of the portable light 10 where it could catch on or snag an external object. The light housing 30 may have an internal cavity for receiving plural sources of electrical power 132, wherein the cavity may be configured to receive fewer of the plural sources of electrical power 132 in side by side arrangement in a location adjacent to the recess 28 than at another location in the cavity. The clip 80 may be pivotable relative to the light housing 30; or the clip 80 may be biased to pivot towards the light housing 30; or the clip 80 may be pivotable relative to the light housing 30 and may be biased to pivot towards the light housing 30. The light housing 30 may include a pivot base 29 extending from the recess 28 thereof, the pivot base 29 supporting a pivot pin 84 on which the clip 80 pivots. The portable light 10 may further include a biasing member 88 biasing the clip 80 to pivot on the pivot pin 84 towards the light housing 30. The portable light 10 may further comprise: an internal assembly 100 including a battery holder 130 or may comprise a battery holder 130, the battery holder 130 extending into a cavity of the light housing 30 for supporting a plurality of sources of electrical power 132, wherein the battery holder 130 supports fewer of the plural sources of electrical power 132 in side by side arrangement in a location adjacent to the recess 28 than at another location in the cavity. The switch 124, 126, 150, 160 may include one or more switch actuators 150, 160, and a switch module 110 interior the light body 20, the switch module 110 including one or more electrical switches 124, 126 positioned adjacent the one or more switch actuators 150, 160 for being actuated thereby. The light source 50, 60 may include a first light source 50, supported in the light head 40 of the light body 20, the first light source 50, including a reflector 56 for directing light produced by the first light source 50, outwardly substantially along a central longitudinal axis of the light body 20. The switch 124, 126, 150, 160 may comprise a switch actuator 150, 160 on the light body 20 between the light head 40 thereof and the clip 80, wherein the switch actuator 150, 160 actuates an electrical switch 124, 126, for selectively energizing the first light source 50, 60. The light source 50, 60 may include a second light source 60 supported in the light head 40 of the light body 20, the second light source 60 directing light outwardly substantially transversely to the central longitudinal axis of the light body 20. The switch 124, 126, 150, 160 may comprise a switch actuator 160 adjacent a lens 44 on a side of the light body 20 through which light from the second light source 60 may be directed, wherein the switch actuator 150, 160 actuates an electrical switch 124, 126, for selectively energizing the second light source 60. The first light source 50, may produce a spot beam and the second light source 60 may produce a flood beam. The light source 50, 60, 180 may include a laser light source 180 supported in the light head 40, the laser light source 180 directing light outwardly substantially along the central longitudinal axis of the light body. The switch 124, 126, 150, 160 may comprise: a first switch actuator 150 on said light body between the light head 40 thereof and the clip 80, wherein the first switch actuator 150 actuates an electrical switch 124 for selectively energizing the first light source 50; and a second switch actuator 160 on the light body 20 in a location substantially diametrically opposite to the first switch actuator 150, wherein the second switch actuator 160 actuates a second electrical switch 126 for selectively energizing the laser light source 180.

A portable light 10 may comprise: a light body 20 including a light head 40 and a light housing 30 extending from the light head 40, the light housing 30 defining an envelope line extending along a side thereof away from the light head 40 along a side of the light housing 30, the light housing 30 having an internal cavity for receiving plural sources of electrical power 132, wherein the cavity is configured to receive fewer of the plural sources of electrical power 132 in side by side arrangement in a first location in the cavity than at another location in the cavity; the light housing 30 having a recess 28 in the side thereof proximate the first location in the cavity thereof and inward of the envelope line; a light source 50, 60 supported by the light head 40 and energizable to produce light; a switch 124, 126, 150, 160 for selectively energizing the light source 50, 60 to produce light; and a clip 80 disposed in the recess 28 of the light housing 30, wherein the shape and size of the recess 28 and the shape and size of the clip 80 are configured so that the clip 80 is substantially in the recess 28 and substantially within the envelope line of the light housing 30, whereby the clip 80 does not extend substantially beyond the envelope of the portable light 10 where it could catch on or snag an external object. The clip 80 may be pivotable relative to the light housing 30; or the clip 80 may be biased to pivot towards the light housing 30; or the clip 80 may be proximate an end of the light housing 30 distal the light head 40; or the clip 80 may be pivotable relative to the light housing 30 and may be biased to pivot towards the light housing 30; or the clip 80 may be proximate an end of the light housing 30 distal the light head 40, may be pivotable relative to the light housing 30 and may be biased to pivot towards the light housing 30. The light housing 30 may include a pivot base 29 extending from the recess 28 thereof, the pivot base 29 supporting a pivot pin 84 on which the clip 80 pivots. The portable light 10 may further include a biasing member 88 biasing the clip 80 to pivot on the pivot pin 84 towards the light housing 30. The portable light 10 may further comprise: an internal assembly 100 including a battery holder 130 or may comprise a battery holder 130, the battery holder 130 extending into the cavity of the light housing 30 for supporting a plurality of sources of electrical power 132, wherein the battery holder 130 supports fewer of the plural sources of electrical power 132 in side by side arrangement in the first location adjacent to the recess 28. The switch 124, 126, 150, 160 may include one or more switch actuators 150, 160, and the portable light 10 may further comprise an internal assembly 100 including a switch module 110 interior the light body 20, the switch module 110 including one or more electrical switches 124, 126 positioned adjacent the one or more switch actuators 150, 160 for being actuated thereby. The light source 50, 60 may include a first light source 50, supported in the light head 40 of the light body 20, the first light source 50, including a reflector 56 for directing light produced by the first light source 50, 60 outwardly substantially along a central longitudinal axis of the light body 20. The switch 124, 126, 150, 160 may comprise a switch actuator 150, 160 on the light body 20 between the light head 40 thereof and the clip 80, wherein the switch actuator 150, 160 actuates an electrical switch 124, 126, for selectively energizing the first light source 50, 60. The light source 50, 60 may include a second light source 60 supported in the light head 40 of the light body 20, the second light source 60 directing light outwardly substantially transversely to the central longitudinal axis of the light body 20. The switch 124, 126, 150, 160 may comprise a switch actuator 160 adjacent a lens 44 on a side of the light body 20 through which light from the second light source 60 is directed, wherein the switch actuator 160 actuates an electrical switch 124, 126, for selectively energizing the second light source 50, 60. The first light source 50 may produce a spot beam and the second light source 60 may produce a flood beam. The light source 50, 60, 180 may include a laser light source 180 supported in the light head 40, the laser light source 180 directing light outwardly substantially along the central longitudinal axis of the light body. The switch 124, 126, 150, 160 may comprise: a first switch actuator 150 on said light body between the light head 40 thereof and the clip 80, wherein the first switch actuator 150 actuates an electrical switch 124 for selectively energizing the first light source 50; and a second switch actuator 160 on the light body 20 in a location substantially diametrically opposite to the first switch actuator 150, wherein the second switch actuator 160 actuates a second electrical switch 126 for selectively energizing the laser light source 180.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate”whether or not expressly stated to be such. It is noted that embodiments of very different sizes, shapes and dimensions may employ the described arrangements.

Although terms such as “up,” “down,” “left,” “right,” “up,” “down,” “front,” “rear,” “side,” “end,” “top,” “bottom,” “forward,” “backward,” “under” and/or “over,” “vertical,” “horizontal,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

The term battery is used herein to refer to an electro-chemical device comprising one or more electro-chemical cells and/or fuel cells, and so a battery may include a single cell or plural cells, whether as individual units or as a packaged unit. A battery is one example of a type of an electrical power source suitable for a portable device. Other devices could include fuel cells, super capacitors, solar cells, and the like. Any of the foregoing may be intended for a single use or for being rechargeable or for both

Various embodiments of a battery may have one or more battery cells, e.g., one, two, three, four, or five or more battery cells, as may be deemed suitable for any particular device. A battery may employ various types and kinds of battery chemistry types, e.g., a carbon-zinc, alkaline, lead acid, nickel-cadmium (Ni—Cd), nickel-metal-hydride (NiMH) or lithium-ion (Li-Ion) battery type, of a suitable number of cells and cell capacity for providing a desired operating time and/or lifetime for a particular device, and may be intended for a single use or for being rechargeable or for both. Examples may include a three or six cell lead acid battery typically producing about 6 volts or about 12 volts, a three cell Ni—Cd battery typically producing about 3.6 volts, a four cell NiMH battery typically producing about 4.8 volts, a five cell NiMH battery producing about 6 volts, a Li-Ion battery typically producing about 3.5 volts, or a two-cell Li-Ion battery typically producing about 7 volts, it being noted that the voltages produced thereby will be higher when approaching full charge and will be lower in discharge, particularly when providing higher current and when reaching a low level of charge, e.g., becoming discharged.

While the present invention has been described in terms of the foregoing example embodiments, variations within the scope and spirit of the present invention as defined by the claims following will be apparent to those skilled in the art. For example, clip 80 may be configured to be entirely within the outline or envelope of portable light 10 or to be substantially therein. The outline or envelope of a light may be defined by one or more of lines 35, 37 and need not be defined by all of those lines.

Clip 80 is illustrated in the example embodiment as being located generally rearward on light body 20 in recess 28 thereof, however, clip 80 may be located at any convenient or desired location on light body 20. Clip 80 is by location, by placement, by size, and/or shape, configured so as to be within an envelope defined by the light housing and thus not easily snag or catch on external objects.

While the example embodiments 10, 10′ as illustrated have light sources 50 and 60 or have light sources 50 and 180, the portable light herein can be configured to include a forwardly directed light source 50, transversely directed light source 60 and laser light source 180. In such instance, wither of actuators 150, 160 can be configured to actuate more than one of light sources 50, 60, 180, as may be convenient and desired.

Preferably, light body 20 may have various raised and/or recessed features, or may have smooth surfaces. In the illustrated light 10, various substantially rectangular recesses are provided for aesthetic purposes and/or for tactile gripping, and may be utilized for receiving various branding and marking information therein.

While certain features may be described as a raised feature, e.g., a ridge, boss, flange, projection or other raised feature, such feature may be positively formed or may be what remains after a recessed feature, e.g., a groove, slot, hole, indentation, recess or other recessed feature, is made. Similarly, while certain features may be described as a recessed feature, e.g., a groove, slot, hole, indentation, recess or other recessed feature, such feature may be positively formed or may be what remains after a raised feature, e.g., a ridge, boss, flange, projection or other raised feature, is made.

Each of the U.S. Provisional Applications, U.S. Patent Applications, and/or U.S. Patents, identified herein is hereby incorporated herein by reference in its entirety, for any purpose and for all purposes irrespective of how it may be referred to or described herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A portable light comprising:
a light body defining a longitudinal axis and including a light head at a first end thereof and a light housing extending away from said light head;
said light housing having an internal cavity for receiving a source of electrical power;
a first light source supported by said light head and energizable to produce light directed outwardly from said light head substantially along the longitudinal axis;
a first actuator at a first location on a half of said light body proximate said first end for selectively energizing said first light source to produce light;
a second light source supported by said light head and energizable to produce light directed outwardly from said light head;
a second actuator at a second location on the half of said light body proximate said first end for selectively energizing said second light source to produce light,
wherein said second actuator is supported on said light body substantially diametrically opposite to said first actuator.

2. The portable light of claim 1 wherein said second light source includes:
a light emitting diode energizable to produce light directed substantially transversely to the longitudinal axis; or
a laser light source energizable to produce light directed outwardly from said light head substantially along the longitudinal axis.

3. The portable light of claim 1 wherein:
said light body has an opening through which light produced by said second light source passes in a direction substantially transverse to the longitudinal axis, and
said second actuator is supported on said light body adjacent to the opening in said light body for the light produced by said second light source.

4. The portable light of claim 3 further comprising a lens in the opening in said light body. wherein said second actuator is supported on said light body immediately rearward of said lens.

5. The portable light of claim 1 further comprising a cover, wherein said light body has an opening in a side thereof in which said cover is disposed, wherein:
if said second light source includes a light emitting diode energizable to produce light directed substantially transversely to the longitudinal axis, then said cover disposed in the opening is a lens through which light produced by said light emitting diode passes in a direction substantially transverse to the longitudinal axis; or
if said second light source includes a laser light source energizable to produce light directed outwardly from said light head substantially along the longitudinal axis, then said cover disposed in the opening provides a notice regarding said laser light source.

6. The portable light of claim 1 wherein said light housing defines an envelope line extending along a side thereof away from said light head along a side of said light housing, said light housing having a recess in the side thereof inward of the envelope line; said portable light further comprising:
a clip disposed in the recess of said light housing, wherein the shape and size of the recess and the shape and size of said clip are configured so that said clip is substantially in the recess and substantially within the envelope line of said light housing,
whereby said clip does not extend substantially beyond the envelope of said portable light where it could catch on or snag an external object.

7. The portable light of claim 6 wherein:
said clip is pivotable relative to said light housing; or
said clip is biased to pivot towards said light housing; or
said clip is proximate an end of said light housing distal said light head; or
said clip is located on a side of said light body opposite to a side of said light body that supports said second actuator; or
any combination of the foregoing.

8. The portable light of claim 6 wherein said source of electrical power includes plural sources of electrical power, and wherein the internal cavity is configured to receive fewer of the plural sources of electrical power in side by side arrangement in a first location in the cavity adjacent the recess than at another location in the cavity.

9. The portable light of claim 1 wherein said first light source produces a spot beam and said second light source produces a flood beam.

10. The portable light of claim 1 wherein said first actuator actuates a first electrical switch for selectively energizing said first light source and said second actuator actuates a second electrical switch for selectively energizing said second light source.

11. The portable light of claim 1 further comprising a first resistance in series with said first light source and a second resistance in series with said second light source, wherein:
said first resistance and said second resistance each have a respective ohmic value to render said portable light intrinsically safe; or
said first resistance and said second resistance each include a fuse, or
said first resistance and said second resistance each include a fuse and have a respective ohmic value to render said portable light intrinsically safe.

12. A portable light comprising:
a light body defining a longitudinal axis and including a light head at a first end thereof and a light housing extending away from said light head;
said light housing having an internal cavity for receiving a source of electrical power;
a first light source supported by said light head and energizable to produce light directed outwardly substantially along the longitudinal axis;
a first actuator for selectively energizing said first light source to produce light;
a second light source supported by said light head and energizable to produce light directed outwardly substantially transversely to the longitudinal axis through an opening in said light body;
a second actuator for selectively energizing said second light source to produce light, wherein said second actuator is supported on said light body adjacent to the opening in said light body for light produced by said second light source; and
wherein said first actuator is supported on said light body substantially diametrically opposite to said second actuator.

13. The portable light of claim 12 wherein said second light source includes:
a light emitting diode energizable to produce the light directed substantially transversely to the longitudinal axis.

14. The portable light of claim 12 wherein:
said second actuator is supported on said light body adjacent to the opening in said light body for the light produced by said second light source.

15. The portable light of claim 12 further comprising a lens in the opening in said light body through which the light produced by said second light source passes in a direction substantially transverse to the longitudinal axis.

16. The portable light of claim 12 wherein said light housing defines an envelope line extending along a side thereof away from said light head along a side of said light housing, said light housing having a recess in the side thereof inward of the envelope line; said portable light further comprising:
a clip disposed in the recess of said light housing, wherein the shape and size of the recess and the shape and size of said clip are configured so that said clip is substantially in the recess and substantially within the envelope line of said light housing,
whereby said clip does not extend substantially beyond the envelope of said portable light where it could catch on or snag an external object.

17. The portable light of claim 16 wherein:
said clip is pivotable relative to said light housing; or
said clip is biased to pivot towards said light housing; or
said clip is proximate an end of said light housing distal said light head; or
said clip is located on a side of said light body opposite to a side of said light body that supports said second actuator; or
any combination of the foregoing.

18. The portable light of claim 16 wherein said source of electrical power includes plural sources of electrical power, and wherein the internal cavity is configured to receive fewer of the plural sources of electrical power in side by side arrangement in a first location in the cavity adjacent the recess than at another location in the cavity.

19. The portable light of claim 12 wherein said first light source produces a spot beam and said second light source produces a flood beam.

20. The portable light of claim 12 wherein said first actuator actuates a first electrical switch for selectively energizing said first light source and said second actuator actuates a second electrical switch for selectively energizing said second light source.

21. The portable light of claim 12 further comprising a lens in the opening in said light body. wherein said second actuator is supported on said light body immediately rearward of said lens.

22. The portable light of claim 12 further comprising a first resistance in series with said first light source and a second resistance in series with said second light source, wherein:
said first resistance and said second resistance each have a respective ohmic value to render said portable light intrinsically safe; or
said first resistance and said second resistance each include a fuse, or
said first resistance and said second resistance each include a fuse and have a respective ohmic value to render said portable light intrinsically safe.

23. A portable light comprising:
a light body defining a longitudinal axis and including a light head at a first end thereof and a light housing extending away from said light head;
said light housing having an internal cavity for receiving a source of electrical power;
a first light source supported by said light head and energizable to produce light directed outwardly substantially along the longitudinal axis;
a first actuator supported by said light body for selectively energizing said first light source to produce light;
a laser light source supported by said light head and energizable to produce light directed outwardly substantially along the longitudinal axis;
a second actuator supported by said light body for selectively energizing said laser light source to produce light,
wherein said second actuator is supported on said light body substantially diametrically opposite to said first actuator.

24. The portable light of claim 23 wherein said light body has an opening in a side thereof in which is disposed a cover providing a notice regarding said laser light source.

25. The portable light of claim 24 wherein said second actuator is supported on said light body immediately rearward of said cover.

26. The portable light of claim 23 wherein said light housing defines an envelope line extending along a side thereof away from said light head along a side of said light housing, said light housing having a recess in the side thereof inward of the envelope line; said portable light further comprising:
a clip disposed in the recess of said light housing, wherein the shape and size of the recess and the shape and size of said clip are configured so that said clip is substantially in the recess and substantially within the envelope line of said light housing,
whereby said clip does not extend substantially beyond the envelope of said portable light where it could catch on or snag an external object.

27. The portable light of claim 26 wherein:
said clip is pivotable relative to said light housing; or
said clip is biased to pivot towards said light housing; or
said clip is proximate an end of said light housing distal said light head; or
said clip is located on a side of said light body opposite to a side of said light body that supports said second actuator; or
any combination of the foregoing.

28. The portable light of claim 26 wherein said source of electrical power includes plural sources of electrical power, and wherein the internal cavity is configured to receive fewer of the plural sources of electrical power in side by side arrangement in a first location in the cavity adjacent the recess than at another location in the cavity.

29. The portable light of claim 23 wherein said first actuator actuates a first electrical switch for selectively energizing said first light source and said second actuator actuates a second electrical switch for selectively energizing said laser light source.

30. The portable light of claim 23 further comprising a first resistance in series with said first light source and a second resistance in series with said laser light source, wherein:
said first resistance and said second resistance each have a respective ohmic value to render said portable light intrinsically safe; or
said first resistance and said second resistance each include a fuse, or
said first resistance and said second resistance each include a fuse and have a respective ohmic value to render said portable light intrinsically safe.
